(19) United States
(12) Patent Application Publication
(10) Pub. No.: US 2024/0383080 A1
(43) Pub. Date: Nov. 21, 2024

(54) COMPOSITE PROCESS AND SYSTEM FOR PREPARING PROFILED MICROCHANNEL PLATE HEAT EXCHANGER

(71) Applicant: Xi'an Jiaotong University, Xi'an (CN)

(72) Inventors: Ting Ma, Xi'an (CN); Dongjun Xu, Xi'an (CN); Zhendong Han, Xi'an (CN); Qiuwang Wang, Xi'an (CN)

(21) Appl. No.: 18/789,605

(22) Filed: Jul. 30, 2024

(30) Foreign Application Priority Data
Aug. 25, 2023 (CN) 202311078473.9

(51) Int. Cl. B23P 15/26; B23H 7/00; B23K 26/342

(52) U.S. Cl. CPC B23P 15/26; B23H 7/00; B23K 26/342

(57) ABSTRACT

The present invention relates to the field of heat exchange technology, specifically to a composite process and system for producing a profiled microchannel plate heat exchanger. This process integrates selective laser melting additive manufacturing with micro electrical discharge machining to create microchannel plate heat exchangers featuring large aspect ratio flow channels and closed profile section flow channels. It enables the fabrication of channels with various cross-sections, such as circular and rectangular, as well as hollow closed profile section flow channels, including micro circular and square holes. The process allows for high-precision machining of microchannels with any aspect ratio. Heat exchangers produced using this composite process can endure extreme high temperatures and pressures, offering superior environmental benefits and contamination-free performance compared to conventional microchannel heat exchangers.

### TECHNICAL FIELD

The present invention belongs to the technical field of heat exchange, and in particular pertains to a composite process and system for preparing a profiled microchannel plate heat exchanger.

### BACKGROUND

A printed circuit board heat exchangers (PCHE) is an efficient and compact microchannel plate heat exchanger, and can transfer heat under severe conditions such as high temperature and high pressure. A conventional process for manufacturing a printed circuit board heat exchanger is as follows: firstly, open-section flow channels are etched on metal plates by an etching process, and then multiple layers of plates are stacked and welded by vacuum diffusion welding to obtain an integrated heat exchanger core, and finally an inlet and an outlet are connected to heads to obtain the printed circuit board heat exchanger. Among them, the etching process is mainly wet chemical etching, the plates are usually made of stainless steel, and flow channel sections are mainly open sections such as semi-circular, airfoil fins and S-shaped fins.

At present, process characteristics of the wet chemical etching restrict flow channel form and material selection of microchannel plate heat exchangers, which in turn limit their high temperature and high pressure performance and reliability. Firstly, since a reaction between an etching solution and a metal to be etched is isotropic, reacting substances can participate in the reaction in any direction, resulting in that a substrate material below a mask material will also be erroneously eroded, resulting in a side etching phenomenon in chemical etching; and second, since a metal surface is gradually passivated as the reaction proceeds, a regeneration rate of the etching solution continuously decreases as an etching depth increases, and decrease in composition consistency results in a regional deviation and an overall decrease in an etching rate. For the above reasons, the wet chemical etching has strict requirements for an aspect ratio (a ratio of a depth to a width of the flow channel section) of the flow channel section, and cannot machine precision flow channels with large aspect ratio sections; the wet chemical etching has low efficiency in the case of materials with strong corrosion resistance such as superalloys, and highly corrosive substances such as hydrochloric acid and nitric acid are generally used, which does not comply with the environmental protection concept of green machining.

In addition, the existing processes can not machine flow channels with closed profile sections such as circular, oval and polygonal sections, which limits pressure bearing performance and compactness of the microchannel plate heat exchangers.

Chinese patent No. CN 104266514 B mentions a method for machining an integral heat exchanger, where wire cutting is used to complete the machining of each layer of channel, and a conventional welding method (electric welding, argon arc welding, etc.) is used to weld and close a cutting line gap of an outer wall surface on each layer. However, only the cutting line gap on the outer surface of the heat exchanger is closed in this method, inner cutting line gaps are still open, and each layer of rib plate is separated from an upper wall surface, resulting in internal substantial intercommunication between the channels of the same layer; and only the outermost layers are substantially connected to each other, and internal solids are not substantially integrated, which greatly increases thermal resistance, and there is still room for improvement in heat exchange efficiency and pressure bearing capacity of the heat exchanger. In addition, a hydraulic diameter of each straight-through channel machined by the method described in the patent is 1-4 mm, and a thickness of a partition wall between the straight-through channels is 1-2 mm. There is still significant room for optimization of characteristic size of the channels and the thickness of the partition wall.

Chinese patent No. CN 105880956 B mentions a microchannel heat exchanger with a porous bottom surface of a micropore structure and a manufacturing method thereof. However, a minimum width of microchannels machined by this method is 0.4 mm, and a minimum spacing between two adjacent microchannels is 0.4 mm, and there is still room for reduction of the two characteristic sizes. Secondly, the heat exchanger prepared by this method cannot withstand high temperature and high pressure.

Chinese patent No. CN 105698563 B mentions a microchannel heat exchanger having a flow dividing-converging structure and a manufacturing method thereof, where the manufacturing method is characterized in that: a metal microchannel substrate is a copper substrate or an aluminum substrate or a stainless steel substrate, and the method can actually not be limited to the machining of the above substrates. For example, the method can be applied to the machining of high temperature alloys, titanium alloys and other materials.

Based on the above analysis, the problems and defects of the prior art are as follows:
1. Inability to achieve large aspect ratio flow channels: traditional processes and manufacturing methods limit the size and shape of flow channels of microchannel plate heat exchangers, and can not achieve large aspect ratio flow channels, that is, the ratio of channel width to length is large. This results in limited heat exchange area of the heat exchangers, affecting heat exchange efficiency and heat exchange performance.
2. Inability to machine closed profile section flow channels: current machining processes can not effectively machine flow channels with closed profile sections such as circular, elliptical and polygonal sections, resulting in unclosed internal cutting line gaps, resulting in internal substantial intercommunication between channels of different layers, affecting pressure bearing performance and compactness of the heat exchangers.
3. Limited characteristic size and partition wall thickness: there is still room for improvement in the microchannel size and the thickness of the partition wall mentioned in existing patents. The size of the microchannels and the thickness of the partition wall have a great influence on the performance of the heat exchangers. Further reducing the characteristic size and increasing the thickness of the partition wall will help to improve the heat exchange performance of the heat exchangers.
4. Inadequate high temperature and high pressure performance: some heat exchangers of

the prior art can not withstand high temperature and high pressure environments, but the ability to withstand high temperature and high pressure environments is necessary in some industrial and energy applications. Therefore, there is a need to develop new microchannel plate heat exchangers to meet heat exchange requirements in high-temperature and high-pressure environments.

Addressing these defects and technical problems requires innovative machining processes and manufacturing methods to achieve further optimization of large aspect ratio flow channels, closed profile section flow channels and microchannel sizes. At the same time, material selection of the heat exchangers needs to be considered to ensure that they can meet the requirements of withstanding high temperature and high pressure environments. The research and development of new profiled microchannel plate heat exchangers will provide a more efficient and reliable solution for heat exchange application in energy, petrochemical, acrospace and other fields.

### SUMMARY

In view of the problems of the prior art, the present invention provides a composite process and system for preparing a profiled microchannel plate heat exchanger.

The present invention is realized as follows: a composite process and system for preparing a profiled microchannel plate heat exchanger, where preparation of the profiled microchannel plate heat exchanger is achieved by combining a plurality of advanced machining techniques such as selective laser melting (SLM), electrical discharge cutting, precision grinding, micro electrical discharge forming and vacuum diffusion welding. Among them, using the selective laser melting (SLM) technique for printing metal substrates has high design freedom; the electrical discharge cutting retains a grinding tolerance of upper and lower surfaces of plates to ensure accuracy of subsequent grinding; the micro electrical discharge forming achieves a complex flow channel structure; and the vacuum diffusion welding ensures quality of connection between multiple layers of plates. The overall solution brings innovation and progress to heat exchanger manufacturing.

Further, the composite process includes the following machining steps:

S101, printing a metal substrate having an array of closed profile section hollow flow channels and a locking process head by selective laser melting technique;

S102, cutting a multi-layer metal substrate with powder cleaned off into single-layer metal plates by an electrical discharge technique, and leaving a grinding tolerance of 0.1-1 mm on upper and lower surfaces of the plates;

S103, connecting the single-layer plates resulting from the cutting to a precision grinder by a countersunk hole of the locking process head and bolts for grinding to ensure that the upper and lower surfaces of the single-layer plates are ground to smooth and flat surfaces with an accurate thickness size after the cutting;

S104, cutting and forming large aspect ratio section flow channels on the single-layer metal substrate plates using array line electrode wires by a micro electrical discharge technique; and

S105, removing metal surface oxidation layers using a weakly acidic solvent such as acetic acid, then re-soaking the plates in an organic solvent such as absolute ethyl alcohol to remove surface oil, and finally cleaning and drying the plates with deionized water and high pressure air; compacting the single-layer plates layer by layer, locking and fixing multiple layers of plates by the process head, and welding the multiple layers of plates by vacuum diffusion welding to obtain a profiled microchannel plate heat exchanger core; and cutting away the process head with high speed wires to obtain a final profiled microchannel plate heat exchanger core.

Further, in S101, in order to prevent deformation of the single-layer substrate during printing, a method of stacking and printing multiple layers of substrate is used, and in order to prevent slag hanging in horizontal printing from blocking microchannels, the printing proceeds vertically along a core straight tube segment.

Further, in S101, before printing, metal powder with a particle size of 5-35 μm is used, argon gas is used as a protective gas, and a preheating function is turned on to heat up to 60° C.; and after printing, high pressure air and high pressure deionized water are used to clean off the powder from the hollow flow channels inside a test piece.

Further, in S104, the array line electrode wires are provided with X large aspect ratio section flow channels which are divided into Y groups, so there are Y electrodes; and the electrode wires of the formed electrodes are arranged spaced, and an array of the large aspect ratio section flow channels on the single-layer metal substrate plate requires X/Y downward pressings of the array electrode for forming.

Further, a characteristic theoretical aspect ratio of the flow channels manufactured by the composite process for preparing the profiled microchannel plate heat exchanger has no range constraint, a minimum characteristic size of the closed profile is not less than 0.1 mm, and a thickness of the single-layer heat exchange plate is not less than 0.3 mm.

Further, the composite process for preparing the profiled microchannel plate heat exchanger allows machining of channels with any section, including profiled section channels.

Further, the composite process for preparing the profiled microchannel plate heat exchanger allows machining of hollow closed profile section flow channels, including profiled section flow channels.

Further, in the channels machined by the composite process for preparing the profiled microchannel plate heat exchanger, the flow channels of the same layer and the flow channels of different layers are independent and isolated from each other, and there is no intra-layer flow and inter-layer flow.

Another object of the present invention is to provide an implementation of a composite process for preparing a profiled microchannel plate heat exchanger:
1. Selective laser melting technique (S101): first, a metal substrate is printed by the laser selective melting technique. This is an additive manufacturing (3D printing) technique that uses a laser beam to scan over a metal powder layer along a predetermined path to melt and solidify metal powder to form a predetermined pattern. By repeating this process, it is possible to print out metal substrates with high design freedom, especially heat exchanger channels with large depth-to-diameter ratios and large aspect ratios.
2. Electrical discharge cutting (S102): then, the multi-layer metal substrate is cut into single-layer metal plates by electrical discharge cutting. The electrical discharge cutting is a method of cutting using high temperature sparks generated by electrode wires. This process can retain grinding tolerance of upper and lower surfaces of the plates to ensure accuracy of subsequent grinding.
3. Precision grinding (S103): next, the upper and lower surfaces of the single-layer metal plates are subject to precision grinding to make the surfaces smooth, flat and have an accurate thickness size. This involves the use of a grinder or other similar tool.
4. Micro electrical discharge forming (S104): then, a complex flow channel structure is made on the precision-ground metal plate by micro electrical discharge forming. This involves the use of a micro electric spark machine which can produce micro sparks on metal surfaces to form complex structures by etching the metal surfaces.
5. Vacuum diffusion welding (S105): finally, multiple layers of plates are welded together by vacuum diffusion welding. The vacuum diffusion welding is a welding method performed under vacuum conditions, and can realize connection between multiple layers of metal plates, making them integrated.

The above is an implementation of preparing the profiled microchannel plate heat exchanger by this composite process. The specific implementation needs to be adjusted according to actual design requirements and equipment conditions.

A yet other object of the present invention is to provide a composite process for preparing a profiled microchannel plate heat exchanger, including:
1) selective laser melting module: using selective laser melting technique, this module prints a metal substrate having an array of closed profile section hollow flow channels and locking process head by laser melting metal powder;
2) electrical discharge cutting module: using an electrical discharge technique, this module cuts a multi-layer metal substrate with the powder cleaned off into single-layer metal plates to ensure that upper and lower surfaces of the plates each have a grinding tolerance of 0.1-1 mm;
3) precision grinding module: this module grinds the single-layer plates resulting from the cutting by connecting a countersunk hole of the locking process head and bolts to a precision grinder to ensure that the upper and lower surfaces of the single-layer plates resulting from the cutting are ground to smooth and flat surfaces with an accurate thickness size after the cutting;
4) micro electrical discharge forming module: using a micro electrical discharge technique, this module cuts and forms large aspect ratio section flow channels on the single-layer metal substrate plates using array line electrode wires to realize a profiled microchannel structure; and
5) cleaning and welding module: using this module, metal surface oxidation layers is removed with a weakly acidic solvent such as acetic acid, then the plates are re-soaked in an organic solvent such as absolute ethyl alcohol to remove surface oil, and finally the plates are cleaned and dried with deionized water and high pressure air; the single-layer plates are compacted layer by layer, multiple layers of plates are locked and fixed by the process head, and the multiple layers of plates are welded by vacuum diffusion welding to obtain a profiled microchannel plate heat exchanger core; and the process head is cut away with high speed wires to obtain a final profiled microchannel plate heat exchanger core.

In combination with the technical solution and the technical problems solved as described above, the claimed technical solution of the present invention has the following advantages and positive effects:

Firstly, the composite process for preparing the profiled microchannel plate heat exchanger according to the present invention achieves a profiled microchannel plate heat exchanger with large aspect ratio flow channels and closed profile section flow channels. Significant technical advances have been made in each step in the composite process for preparing the profiled microchannel plate heat exchanger.

The following are specific technical advances for each step:
1. Machining step S101: printing the metal substrate by the laser selective melting technique.

Significant technical advances: The selective laser melting technique is a fast prototyping technique that makes it possible to print out complex profiled microchannel plate heat exchanger metal substrates from the metal powder according to designed structural data. Compared with traditional machining, the selective laser melting technique has the following advantages: more tolerant material selectivity, higher production efficiency and greater design freedom; compared with two-dimensional machining of etching process, the selective laser melting technique can produce more complicated and precise structures in three-dimensional spaces; and compared with traditional subtractive manufacturing, the selective laser melting technique is not limited to cutting performance of materials and can machine a wider range of materials, the depth-to-diameter ratio of machined micropores can break through 100:1, powder materials can be recycled and sieved for reuse, thereby saving a large amount of materials.
2. Machining step S102: cutting the multi-layer metal substrate into single-layer plates by the electrical discharge cutting.

Significant technical advances: the electrical discharge cutting technique allows the multi-layer metal substrate to be cut into single-layer plates with high precision, and the cutting process will not cause physical deformation or mechanical stress, thereby ensuring that the plates resulting from the cutting will maintain highly accurate size and flatness. This is crucial for the preparation of thin plate materials for microchannel plate heat exchangers, and traditional mechanical cutting leads to large deformation and dimensional errors.
3. Machining step S103: precision grinding of the single-layer plates.

Significant technical advances: the single-layer metal plates are ground by the precision grinder, which can ensure that the surfaces are smooth and flat and maintain the accurate thickness size required by the design. This grinding machining method is more accurate than traditional mechanical grinding, and can achieve micron-scale dimensional accuracy, thereby ensuring heat exchange performance and scaling of the heat exchanger.
4. Machining step S104: forming the large aspect ratio section flow channels by micro electrical discharge cutting.

Significant technical advances: the micro electrical discharge cutting technique enables making of the complex microchannel structures on the surfaces of the metal plates, including the large aspect ratio section flow channels. This enables the heat exchanger to achieve higher heat transfer efficiency and a larger surface area in a limited space, thereby improving performance of the heat exchanger.
5. Machining step S105: efficient cleaning and welding process.

Significant technical advances: weakly acidic and organic solvents are used in the cleaning process to effectively remove the oxidation layers and oils on the metal surfaces to ensure quality of welded joints. The welding process uses the vacuum diffusion welding technique which is a filler metal-free welding method under high temperature and high vacuum, capable of avoiding contamination by gas and impurities during the welding process, which ensures strength and tightness of the welded joints.

The composite process for preparing the profiled microchannel plate heat exchanger combines the advanced techniques such as the selective laser melting, electrical discharge cutting, precision grinding, micro electrical discharge cutting, cleaning and high-temperature vacuum welding, which significantly improves precision, efficiency and performance of the preparation process and realizes the manufacturing of the profiled microchannel plate heat exchanger.

Secondly, considering the technical solution as a whole or from the perspective of products, the technical effects and advantages of the claimed technical solution of the present invention are specifically described as follows:
1. Channels of any section may be machined, including but not limited to circular, rectangular and other profiled section channels.
2. Hollow closed profile section flow channels can be machined, including and not limited to micro circular hole, micro square hole and other profiled section channels.
3. High-precision machining of microchannels with any aspect ratio can be achieved, including but not limited to micro rectangular and other profiled section channels.
4. Characteristic theoretical aspect ratios of the flow channels manufactured by the process have no range constraint, a minimum characteristic size of the closed profile is not less than 0.1 mm, and the thickness of the single-layer heat exchange plate is not less than 0.3 mm, and limit sizes of the manufactured microchannels are greatly reduced.
5. The vast majority of metallic materials can be machined, including but not limited to superalloys, titanium alloys, aluminum alloys, and the like.
6. The use of array line electrodes arranged spaced can effectively improve machining quality and efficiency of microchannel arrays.
7. Whether circular or rectangular channels, the flow channels of the same layer and the flow channels of different layers are independent and isolated from each other, and there is no intra-layer flow and inter-layer flow. The vacuum diffusion welding is used between the plates to achieve atomic level diffusion bonding, which effectively improves the heat exchange efficiency and pressure resistance.
8. Compared with general microchannel heat exchangers, the microchannel heat exchanger according to the present invention can withstand extreme high temperature and high pressure conditions.
9. The technical solution is more environmentally friendly and free of contamination.

Thirdly, the expected profit and commercial value of transforming the technical solution of the present invention are as follows: the profiled microchannel plate heat exchangers can be efficiently machined and manufactured, which improves technology readiness level and promotes low-carbon, green, and environmentally friendly development of the industry. At the same time, additive manufacturing and electromachining belong to high-end advanced manufacturing, and this technical solution is beneficial to promote the application and development of high-end advanced manufacturing. Compared to conventional chemical etching process for microchannel plate heat exchangers such as printed circuit board heat exchangers, channels with any aspect ratio section shapes as well as large aspect ratio channels can be machined.

### BRIEF DESCRIPTION OF THE DRAWINGS

FIG. 1 is a flow diagram of a composite process for preparing a profiled microchannel plate heat exchanger according to an embodiment of the present invention.

FIG. 2 is a structural schematic diagram of a multi-layer metal substrate structure according to an embodiment of the present invention.

FIG. 3 is a schematic diagram of electrical discharge cutting of a multi-layer metal substrate according to an embodiment of the present invention.

FIG. 4 is a schematic diagram of a single-layer metal substrate plate after cutting according to an embodiment of the present invention.

FIG. 5 is a schematic diagram of a single-layer metal substrate plate after grinding of upper and lower surfaces according to an embodiment of the present invention.

FIG. 6 is a schematic diagram of alternate arrangement of electrode wires of an array electrode according to an embodiment of the present invention.

FIG. 7 is a schematic diagram of an overall structure of an array electrode according to an embodiment of the present invention.

FIG. 8 is a schematic diagram of a plate of a profiled microchannel plate heat exchanger prepared by a composite process according to an embodiment of the present invention.

FIG. 9 is a schematic diagram of diffusion welding with a process head uncut according to an embodiment of the present invention.

FIG. 10 is a schematic diagram of a profiled microchannel plate heat exchanger core with a process head cut according to an embodiment of the present invention.

### DESCRIPTION OF THE EMBODIMENTS

In order to make the objects, technical solution and advantages of the present invention more clear, the present invention will be further described in detail below in conjunction with embodiments. It should be understood that the specific embodiments described herein are merely illustrative of the present invention and are not intended to limit the present invention.

An embodiment of the present invention provides a composite process for preparing a profiled microchannel plate heat exchanger, where profiled channels refer to internal flow channels of the heat exchanger having large aspect ratio section shapes such as rectangular, rounded rectangular, semi-circular sections as well as closed profile shapes such as circular, oval and polygonal profiles, including but not limited to flow channels having a combination of the sections of the above shapes.

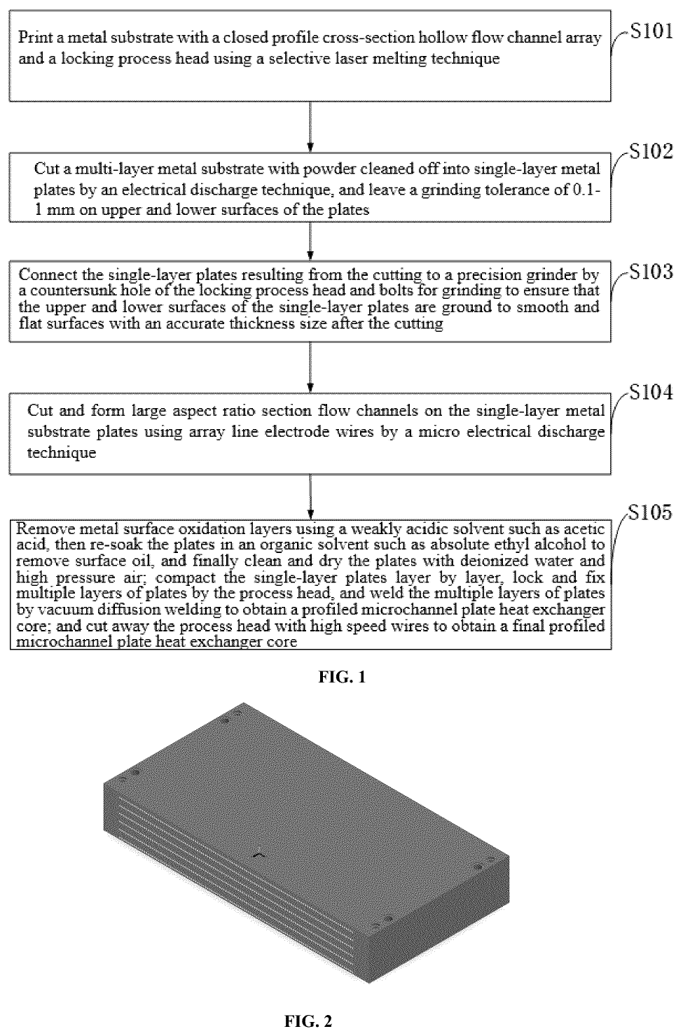

As shown in FIG. 1, the composite process for preparing the profiled microchannel plate heat exchanger according to an embodiment of the present invention includes the following main machining steps:

S101, printing a metal substrate having an array of closed profile section hollow flow channels and a locking process head by selective laser melting technique;

S102, cutting a multi-layer metal substrate with powder cleaned off into single-layer metal plates by an electrical discharge technique, and leaving a grinding tolerance of 0.1-1 mm on upper and lower surfaces of the plates;

S103, connecting the single-layer plates resulting from the cutting to a precision grinder

by a countersunk hole of the locking process head and bolts for grinding to ensure that the upper and lower surfaces of the single-layer plates are ground to smooth and flat surfaces with an accurate thickness size after the cutting;

S104, cutting and forming large aspect ratio section flow channels on the single-layer metal substrate plates using array line electrode wires by a micro electrical discharge technique; and

S105, removing metal surface oxidation layers using a weakly acidic solvent such as acetic acid, then re-soaking the plates in an organic solvent such as absolute ethyl alcohol to remove surface oil, and finally cleaning and drying the plates with deionized water and high pressure air; compacting the single-layer plates layer by layer, locking and fixing multiple layers of plates by the process head, and welding the multiple layers of plates by vacuum diffusion welding to obtain a profiled microchannel plate heat exchanger core; and cutting away the process head with high speed wires to obtain a final profiled microchannel plate heat exchanger core.

In S101, in order to prevent deformation of the single-layer substrate during printing, a method of stacking and printing multiple layers of substrate is used, and the multi-layer metal substrate is as shown in FIG. 2; in order to prevent slag hanging in horizontal printing from blocking microchannels, the printing proceeds vertically along a core straight tube segment; before printing, metal powder with a particle size of 5-35 μm is used, argon gas is used as a protective gas, and a preheating function is turned on to heat up to 60° C.; and after printing, high pressure air and high pressure deionized water are used to clean off the powder from the hollow flow channels inside a test piece.

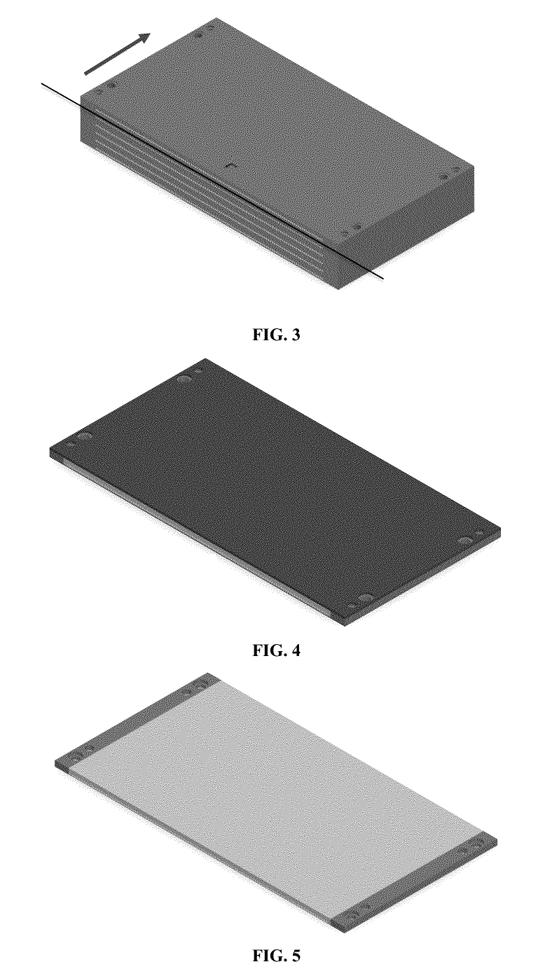

In S102, as shown in FIG. 3, the multi-layer metal substrate is cut into single-layer metal plates using the electrode wires; and the single-layer metal plate resulting from the cutting is as shown in FIG. 4.

In S103, as shown in FIG. 5, the upper and lower surfaces of the single-layer plates are ground to smooth and flat surfaces with an accurate thickness size.

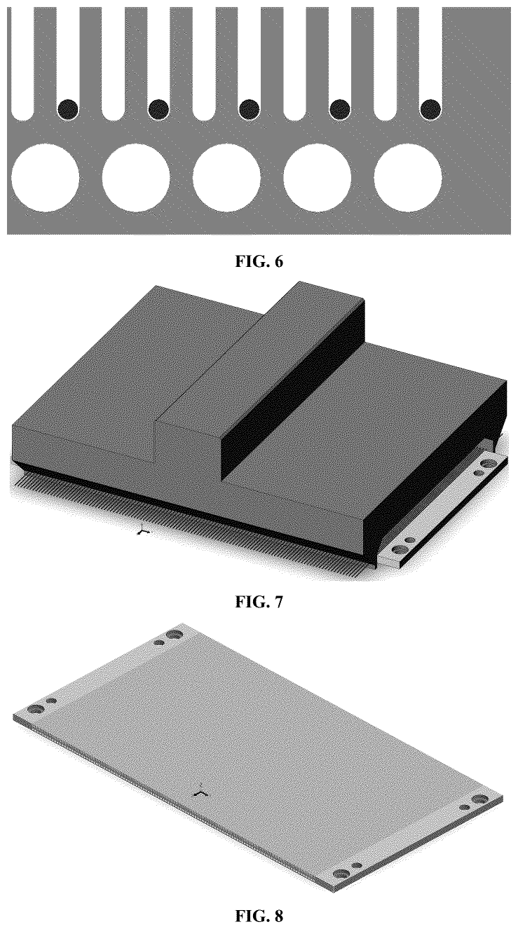

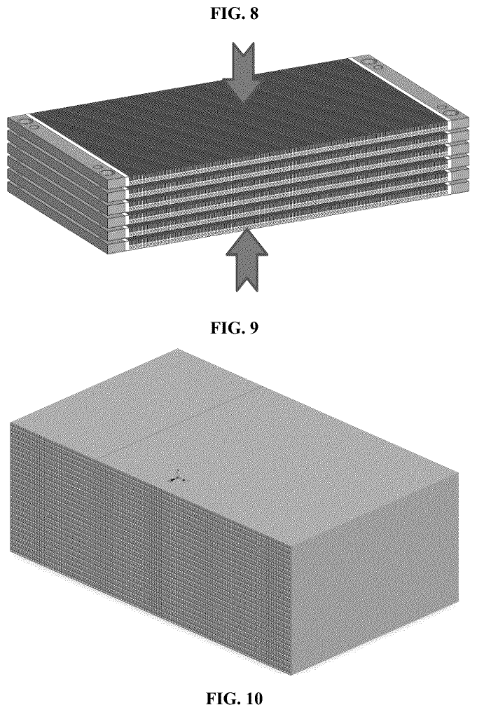

In S104, the array line electrode wires are characterized in that: in order to reduce interaction between electrodes during machining, X large aspect ratio section flow channels are provided and divided into Y groups, so there are Y electrodes; and the electrode wires of the formed electrodes are arranged spaced, and an array of the large aspect ratio section flow channels on the single-layer metal substrate plate requires X/Y downward pressing of the array electrode for forming. A schematic diagram of the alternate arrangement of the electrode wires of the array electrode is as shown in FIG. 6, a schematic diagram of an overall structure of the array electrode is as shown in FIG. 7, and the plates of the profiled microchannel plate heat exchanger prepared by the composite process are as shown in FIG. 8. Advantages of this step: both quality of inner surfaces of the flow channels and machining efficiency are balanced, which facilitates removal of ablation products, and improves machining stability and machining quality.

In S105, as shown in FIG. 9, the vacuum diffusion welding is used to obtain the profiled microchannel plate heat exchanger core; and as shown in FIG. 10, high speed wires are used to cut away the process head to obtain the final profiled microchannel plate heat exchanger core.

Preferably, a characteristic theoretical aspect ratio of the flow channels manufactured by the composite process has no range constraint, a minimum characteristic size of the closed profile is not less than 0.1 mm, and a thickness of the single-layer heat exchange plate is not less than 0.3mm.

Process parameters of the selective laser melting (SLM) technique are as follows: a spot diameter is 20-80 μm, a laser power is 50-200 w, a scanning speed is 500-1500 mm/s, a scanning pitch is 0.05-0.1 mm, strip scanning is used, and a lamination thickness is 10-50 μm.

Process parameters of micro electrical discharge technique are as follows: the electrode wires are molybdenum wires with a diameter of 0.1 mm, a machining current is 1-3 A, a pulse width is 1-5us, and line electrode wire speed is 1-4 mm/s.

The flow channels with the closed profile section are micro circular channels, and the flow channels with a large aspect ratio profile section are micro square channels with rounded corners, a hydraulic diameter of the micro circular channels is not less than 0.1 mm, the aspect ratio of the micro square channels is not more than 100, and a solid thickness between the channels is not less than 0.1 mm.

Upper and lower surface roughness after grinding of the plates is not be higher than Ra0.4μm.

Due to small diameter (micron scale), large number and long flow length of printed circuit plate heat exchanger channels, circular microchannels have a great depth-to-diameter ratio, and belong to the category of micropores which are very difficult to be machined by traditional processes. Moreover, due to the large number of channels, the machining efficiency must be considered. Although micropore machines can meet dimensional requirements for machining, their efficiency is very low, and they have no practical engineering application valuc.

The SLM process has unique advantages in manufacturing heat exchangers with complex hollow structures, is applicable to materials of any material properties, and can machine corrosion-resistant and hard-to-cut materials, such as superalloys. Therefore, the SLM process is selected to manufacture hollow flow channel members with closed profile sections.

Because the superalloys are hard-to-cut metals with high hardness, high viscosity and high cutting difficulty, and thin-wall array structures can not be machined by the traditional machining, the electrical discharge forming technique with less residual stress and high machining efficiency are considered to machine the large aspect ratio flow channels.

As an optimization of an embodiment of the present invention, in S102, the electrode wires are used to cut the multilayer metal substrate. The electrode wires are usually used for wire electrical discharge cutting, which is a precision cutting method that uses high temperature generated by electric spark to cut metals. The electrode wires are usually made of copper, tungsten or other conductive materials. During cutting, electric sparks are generated between the electrode wires and a workpiece, and the sparks melt and evaporate a portion of a surface of the workpiece, thereby achieving the purpose of cutting. The schematic diagram as shown in FIG. 3 shows a position of the electrode wires during cutting and an area at which the sparks generate. The single-layer metal substrate plate resulting from the cutting is as shown in FIG. 4.

As an optimization of an embodiment of the present invention, S103 involves grinding the upper and lower surfaces of the single-layer metal plates resulting from the cutting to make them smooth and flat. This process generally involves removing rough portions of the metal surface by physical abrasion using tools such as grinders or grinding wheels to achieve a smooth effect. This process also ensures accurate thickness size of the plates. FIG. 5 shows a comparison of the metal plates before and after grinding.

As an optimization of an embodiment of the present invention, in S104, characteristics and arrangement of the array electrode wires are described in detail. To reduce the interaction between the electrodes, X large aspect ratio section flow channels are provided and divided into Y groups. This means that there are X/Y flow channels in each group, while the number of electrodes is Y. On the single-layer metal substrate plates, an array of flow channels requires X/Y downward pressing of the array electrode for forming. FIG. 6 shows the arrangement of electrode wires, while FIG. 7 shows an overall structure of the array electrode. Finally, by this method, the profiled microchannel plate heat exchanger plates as shown in FIG. 8 can be prepared.

As an optimization of an embodiment of the present invention, in S105, the profiled microchannel plate heat exchanger core is obtained by the vacuum diffusion welding. The vacuum diffusion welding is a welding method performed under vacuum conditions, which uses diffusion between metal atoms to achieve welding. This method can achieve tight connection of metals without any welding flux. Then, as shown in FIG. 10, high speed wires are used to cut away the process head to obtain the final profiled microchannel plate heat exchanger core. This step involves the use of a quick wire electrical discharge wire cutter to perform precise cutting at specific locations on the metal plates to remove unwanted portions to achieve the final shape and size.

The composite process for preparing the profiled microchannel plate heat exchanger according to the embodiment of the present invention has the following characteristics:
1. Channels of any section may be machined, including but not limited to circular, rectangular and other profiled section channels.
2. Hollow closed profile section flow channels can be machined, including and not limited to micro circular hole, micro square hole and other profiled section channels.
3. High-precision machining of microchannels with any aspect ratio can be achieved, including but not limited to micro rectangular and other profiled section channels.
4. Characteristic theoretical aspect ratios of the flow channels manufactured by the process have no range constraint, a minimum characteristic size of the closed profile is not less than 0.1 mm, and the thickness of the single-layer heat exchange plate is not less than 0.3 mm, and limit sizes of the manufactured microchannels are greatly reduced.
5. The vast majority of metallic materials can be machined, including but not limited to superalloys, titanium alloys, aluminum alloys, and the like.
6. The use of array line electrodes arranged spaced effectively improves machining quality and efficiency of microchannel arrays.
7. Whether circular or rectangular channels, the flow channels of the same layer and the flow channels of different layers are independent and isolated from each other, and there is no intra-layer flow and inter-layer flow. The plates are welded together by vacuum diffusion welding, which effectively improves the heat exchange efficiency and pressure resistance.
8. Compared with general microchannel heat exchangers, the microchannel heat exchanger according to the present invention can withstand extreme high temperature and high pressure conditions.
9. The composite process is more environmentally friendly and free of contamination.

The composite process for preparing the profiled microchannel plate heat exchanger according to an embodiment of the present invention is a composite technique process route combining a plurality of processes based on selective laser melting additive manufacturing technique and a micro electrical discharge forming process, which is referred to as an SED technique process route. A main machining path of the process route is that the circular channels of the cold side of the profiled microchannel precooling heat exchanger are integrally formed by the SLM additive manufacturing technique, and then the square channels of the hot side are formed by the EDM electrical discharge cutting and ablation on the integrally formed core plate, and finally the core plate is smoothed, and then various layers of core plates are combined and spliced by diffusion welding to form a final profiled microchannel precooling heat exchanger principle prototype. Specific machining parameters and machining processes involved in the SED technique process route are described in detail below.

1. Firstly, the SLM additive manufacturing technique was used to machine a substrate with a core plate having a 0.6 mm diameter circular channel array structure and a countersunk hole (the countersunk hole here was not related to the structure of the principle prototype and was only used as a means for fastening and positioning in subsequent machining, without precision requirements for the aperture), a size of the resulting single-layer substrate plate was 373 mm×24 mm×1.75 mm (including edge size), GH4169 powder with a particle size of 5-35 μm was selected as the forming powder, and a diameter of a customized micro spot was 60 μm; in addition, in order to prevent deformation and warping during machining due to printing only a single-layer substrate (with a thickness of about 1.75 mm), which may affect flatness of subsequent core plates, a machining method of stacking and printing multiple layers of substrate plates was used, and cach stacked substrate consisted of 5 single-layer plates with a thickness of about 8.75 mm. During printing, since the microchannel had the diameter of 0.6 mm, in order to prevent slag blockage caused by printing in the direction of the core flow channel, the printing proceeded vertically along a core straight tube segment perpendicular to the direction of the flow channel, and a multi-layer substrate model containing the printed micro circular channels and a machined test piece are as shown in FIG. 2.

2. After a surface of the stacked substrate core formed by the above printing was simply cleaned, cutting was performed using high speed wires (molybdenum wires with a wire diameter of 0.18 mm). As shown in FIG. 3, the substrate containing 5 layers of plates was cut into single-layer plates with a thickness of 2.0 mm, and a grinding tolerance of 0.2 mm was left on upper and lower surfaces of each layer of core plate during cutting. A single-layer substrate plate model resulting from the cutting and the machined test piece are as shown in FIG. 4.

3. The single-layer plates resulting from the cutting were placed in an ethanol solution for ultrasonic cleaning to remove impurities and dirt generated during cutting from the surface, and then the countersunk hole printed in the above process was connected to a precision grinder by corresponding matching bolts for grinding. As shown in FIG. 5, it was ensured that the upper and lower surfaces of the single-layer plates resulting from the cutting were ground to smooth and flat surfaces with an accurate thickness size.

4. The ground single-layer substrate plates were aligned at specified positions, and before electrode ablation, thin-wall micro fins were machined on a high-temperature side of the substrate plate using the electrical discharge forming process. In addition, since thin-wall microchannels were arranged in an array with a small channel spacing of only 0.2 mm, multiple electrodes needed to be pressed down in parallel to perform ablation. In order to minimize interaction between adjacent electrodes during machining, the electrode wires forming the electrode were arranged spaced, as shown in FIG. 6. An array of molybdenum wires with a diameter of 0.1 mm was used as a working electrode, and the electrode structure is as shown in FIG. 7, a machining short-circuit current was 1 A, a pulse width was 6 μs, and an open circuit voltage was 150 V. All square fin structures on a single substrate plate required two-pass downward forming of the electrode, which took into account quality of the thin wall and channel efficiency, facilitated removal of ablation products, and improved machining stability. FIG. 8 is a schematic diagram of a model of an electrical discharge forming process test piece which was finally formed as the machined test piece resulting from the electrical discharge forming. Rectangular microchannels with a width of 0.2 mm, a height of 1 mm and a spacing of 0.2 mm were cut on the GH4169 plates.

5. The single-layer substrate plates resulting from the electrical discharge forming were subject to ultrasonic cleaning. Since the above-mentioned process mainly used additives and subtractives to machine the test piece; after completion of the machining, due to small microchannels, some residues or debris from the machining were trapped in the small flow channels, the plates were sealed with plastic film for welding after the completion of the cleaning;

and during welding, the machined plates were stacked layer by layer in advance and compacted, temperature and pressure were adjusted to combine the plates by diffusion welding for forming, and finally the high speed wires were used to cut away the initial process countersunk head end from the formed test piece to obtain the final profiled channel printed circuit plate heat exchanger core.

TABLE 1
Test items, method and conclusion of core fin

| | | Metering | Technical | | |
|---|---|---|---|---|---|
| Test item | Test method | environment | requirements | Measured value | Conclusion |
| Part | Micrometer | 20 ± 2° C./40% | 2.01 mm-2.05 mm | 2.012 mm-2.041 mm | Pass |
| thickness | | | | | |
| Surface | Roughness | 20 ± 2° C./40% | Ra0.8 μm | Ra0.204 μm- | Pass |
| roughness | tester | | | Ra0.561 μm | |
| Parallelism | Dial gauge | 20 ± 2° C./40% | 0.01/100 mm | 0.001/100 mm- | Pass |
| | | | | 0.009/100 mm | |
| Groove | Universal | 20 ± 2° C./40% | 1 ± 0.02 mm | 0.9819 m-1.0191 mm | Pass |
| depth | tool | | | | |
| | microscope | | | | |
| Groove | Universal | 20 ± 2° C./40% | 0.2 ± 0.01 mm | 0.200 mm-0.207 mm | Pass |
| width | tool | | | | |
| | microscope | | | | |
| Machining | Dial gauge | 20 ± 2° C./40% | 0.01/100 mm | 0.005/100 mm- | Pass |
| deformation | | | | 0.010/100 mm | |
| Surface | 50X | 20 ± 2° C./40% | No scratch | No scratch or | Pass |
| integrity | magnifier | | or scoring | scoring is seen | |
| | | | on the surface | | |
| Excess | 0.7 MPa air | 20 ± 2° C./40% | Internal flow | No excess material | Pass |
| material in | press and | | channels are | is seen | |
| the flow | filter paper | | clean and | | |
| channel | | | free of blockage | | |

Some of measured data for the present invention during development is shown in Table 2.

TABLE 2
Some of measured data during development

| | Part | | | | | | | |
|---|---|---|---|---|---|---|---|---|
| | thick- | | | | | | | |
| Test | ness | Surface | | Groove | Groove | Machining | | |
| piece | (mm) | roughness | Parallelism | depth | width | deformation | Surface integrity | Excess material |
| No. 1 fin | 2.028 | Ra0.4 μm | 0.01/100 mm | 1.01 mm | 0.205 mm | 0.005/100 mm | No scratch or scoring | Internal flow channels are |
| | | | | | | | on the surface | clean and free of blockage |
| No. 2 fin | 2.025 | | 0.01/100 mm | 0.99 mm | 0.200 mm | 0.007/100 mm | No scratch or scoring | Internal flow channels are |
| | | | | | | | on the surface | clean and free of blockage |
| No. 3 fin | 2.021 | Ra0.4 μm | | 1.02 mm | 0.203 mm | 0.007/100 mm | No scratch or scoring | Internal flow channels are |
| | | | | | | | on the surface | clean and free of blockage |
| No. 4 fin | 2.031 | Ra0.4 μm | 0.01/100 mm | 1.01 mm | 0.202 mm | 0.010/100 mm | No scratch or scoring | Intemal flow channels are |
| | | | | | | | on the surface | clean and free of blockage |
| No. 5 fin | 2.027 | Ra0.4 μm | 0.01/100 mm | 1.00 mm | 0.201 mm | 0.008/100 mm | No scratch or scoring | Internal flow channels are |
| | | | | | | | on the surface | clean and free of blockage |
| No. 6 fin | 2.024 | Ra0.3 μm | 0.01/100 mm | 1.01 mm | 0.200 mm | 0.006/100 mm | No scratch or scoring | Interval flow channels are |
| | | | | | | | on the surface | clear and free of blockage |
| No. 7 fin | 2.027 | Ra0.3 μm | 0.01/100 mm | 0.98 mm | 0.201 mm | 0.005/100 mm | No scratch of scoring | Internal flow channels are |
| | | | | | | | on the surface | clean and free of blockage |
| No. 8 fin | 2.033 | Ra0.4 μm | 0.01/100 mm | 0.99 mm | 0.200 mm | 0.007/100 mm | No scratch or scoring | Internal flow channels are |
| | | | | | | | on the surface | clean and free of blockage |
| No. 9 fin | 2.022 | Ra0.3 μm | 0.01/100 mm | 1.00 mm | 0.204 mm | 0.005/100 mm | No scratch or scoring | Internal dow channels are |
| | | | | | | | on the surface | clear and free of blockage |
| No. 10 fin | 2.035 | Ra0.4 μm | 0.01/100 mm | 1.01 mm | 0.203 mm | 0.007/100 mm | No scratch or scoring | Internal flow channels are |
| | | | | | | | on the surface | clean and free of blockage |

A total of 100 fins prepared were measured for fin thickness, flow channel depth and width using a micrometer and a universal tool microscope, and found that the process stability was excellent, and the aspect ratio of the flow channels reached 5:1.

A CNC scanner was used to measure diameter of circular section channels, the diameter of the circular hole was found to be 0.2-0.214 mm, a total length of the flow channels was 50 mm, and the depth-to-diameter ratio of the flow channels reached 125.

The composite process for preparing the profiled microchannel plate heat exchanger according to an embodiment of the present invention included a plurality of steps, and an embodiment of each step is as follows.

### Embodiment I:

Machining step S101: a metal substrate having an array of closed profile section hollow flow channels and a locking process head was printed by selective laser melting (SLM) technique. Implementation: In a machine equipped with a selective laser melting apparatus,

designed structural data of the profiled microchannel plate heat exchanger were input, the metal substrate was printed layer by layer using laser melting metal powder, and the locking process head was added at a specific position.

### Embodiment II: Machining step S102: a multi-layer metal substrate with powder cleaned off was cut into

single-layer metal plates by an electrical discharge technique, and a grinding tolerance of 0.1-1 mm was left on upper and lower surfaces of the plates.

Implementation: the printed multi-layer metal substrate was cleaned to remove residual powder and cut into single-layer metal plates by an electrical discharge cutting technique to ensure that a certain grinding tolerance was left on the upper and lower surfaces for subsequent grinding machining.

### Embodiment III:

Machining step S103: the single-layer plates resulting from the cutting were connected to a precision grinder by a countersunk hole of the locking process head and bolts for grinding to ensure that the upper and lower surfaces of the single-layer plates were ground to smooth and flat surfaces with an accurate thickness size after the cutting.

Implementation: the single-layer metal plates resulting from the cutting were placed in the countersunk hole of the locking process head and fixed by bolts, and then placed on a precision grinder for grinding to ensure that the upper and lower surfaces of the plates were smooth and flat and reached the accurate thickness size required by design.

### Embodiment IV:

Machining step S104: large aspect ratio section flow channels were formed by cutting on the single-layer metal substrate plates using array line electrode wires by a micro electrical discharge technique.

Implementation: using the micro electrical discharge technique, precision cutting was carried out on the surfaces of the single-layer metal plates through the array line electrode wires to form profiled microchannel structures, ensuring that the channels had a large aspect ratio to improve heat transfer efficiency.

The above are four specific embodiments and implementations of the composite process for preparing the profiled microchannel plate heat exchanger. The whole process includes laser printing, electrical discharge cutting, grinding, micro electrical discharge cutting, cleaning, compaction welding and high speed wire cutting, which together complete the preparation process of the profiled microchannel plate heat exchanger.

The above description is merely specific implementation of the present invention, but the scope of protection of the present invention is not limited thereto, and any modifications, equivalent substitutions, improvements, etc. made by any person skilled in the art within the technical scope disclosed in the present invention within the spirit and principles of the present invention should be covered within the scope of protection of the present invention.

What is claimed is:

1. A composite process for preparing a profiled microchannel plate heat exchanger, wherein preparation of the profiled microchannel plate heat exchanger is achieved by combining a plurality of processing techniques such as selective laser melting technique, electrical discharge cutting, precision grinding, micro electrical discharge forming and vacuum diffusion welding; the selective laser melting technique prints metal substrate with design freedom, heat exchanger channels have a large depth-to-diameter ratio, and heat exchanger channel sections have a large aspect ratio; the electrical discharge cutting retains a grinding tolerance of upper and lower surfaces of plates to ensure accuracy of subsequent grinding; the grinding and the electrical discharge cutting achieve a complex flow channel structure; and the vacuum diffusion welding ensures an integrated metallurgical connection of multiple layers of plates; and
the composite process comprises the following machining steps:
S101, printing a metal substrate having an array of closed profile section hollow flow channels and a locking process head by selective laser melting technique;
S102, cutting a multi-layer metal substrate with powder cleaned off into single-layer metal plates by an electrical discharge technique, and leaving a grinding tolerance of 0.1-1 mm on upper and lower surfaces of the plates;
S103, connecting the single-layer plates resulting from the cutting to a precision grinder by a countersunk hole of the locking process head and bolts for grinding to ensure that the upper and lower surfaces of the single-layer plates are ground to smooth and flat surfaces with an accurate thickness size after the cutting;
S104, cutting and forming large aspect ratio section flow channels on the single-layer metal substrate plates using array line electrode wires by a micro electrical discharge technique; and
S105, removing metal surface oxidation layers using acetic acid, then re-soaking the plates in absolute ethyl alcohol to remove surface oil, and finally cleaning and drying the plates with deionized water and high pressure air; compacting the single-layer plates layer by layer, locking and fixing multiple layers of plates by the process head, and welding the multiple layers of plates by the vacuum diffusion welding to obtain a profiled microchannel plate heat exchanger core; and cutting away the process head with high speed wires to obtain a final profiled microchannel plate heat exchanger core;
in S101, in order to prevent deformation of the single-layer substrate during printing, a method of stacking and printing multiple layers of substrate is used, and in order to prevent slag hanging in horizontal printing from blocking microchannels, the printing proceeds vertically along a core straight tube segment;
before printing, metal powder with a particle size of 5-35 μm is used, argon gas is used as a protective gas, and a preheating function is turned on to heat up to 60° C.; and after printing, high pressure air and high pressure deionized water are used to clean off the powder from the hollow flow channels inside a test piece;
in S104, the array line electrode wires are provided with X large aspect ratio section flow channels which are divided into Y groups, so there are Y electrodes; and the electrode wires of the formed electrodes are arranged spaced, and an array of the large aspect ratio section flow channels on the single-layer metal substrate plate requires X/Y downward pressing of the array electrode for forming; and
a characteristic theoretical aspect ratio of the flow channels manufactured by the composite process for preparing the profiled microchannel plate heat exchanger has no range constraint, a minimum characteristic size of the closed profile is not less than 0.1 mm, and a thickness of the single-layer heat exchange plate is not less than 0.3 mm.

2. The composite process for preparing a profiled microchannel plate heat exchanger according to claim 1, wherein the composite process for preparing the profiled microchannel plate heat exchanger allows machining of channels with any section, comprising profiled section channels.

3. The composite process for preparing a profiled microchannel plate heat exchanger according to claim 1, wherein the composite process for preparing the profiled microchannel plate heat exchanger allows machining of hollow closed profile section flow channels, comprising profiled section flow channels.

4. The composite process for preparing a profiled microchannel plate heat exchanger according to claim 1, wherein in the channels processed by the composite process for preparing the profiled microchannel plate heat exchanger, the flow channels of the same layer and the flow channels of different layers are independent and isolated from each other, and there is no intra-layer flow and inter-layer flow.

5. The composite process for preparing a profiled microchannel plate heat exchanger according to claim 1, further comprising:
(1) selective laser melting: printing a metal substrate by the laser selective melting technique; scan with a laser beam over a metal powder layer along a predetermined path to melt and solidify metal powder to form a predetermined pattern; and repeating this process to print out a metal substrate with high design freedom for making the heat exchanger channels with the large depth-to-diameter ratio and the large aspect ratio;
(2) electrical discharge cutting: cutting the multi-layer metal substrate into single-layer metal plates by electrical discharge cutting;
(3) precision grinding: precision grinding the upper and lower surfaces of the single-layer metal plates to make the surfaces smooth, flat and have an accurate thickness size;
(4) micro electrical discharge forming: making a complex flow channel structure on the precision-ground metal plate by micro electrical discharge forming; and
(5) vacuum diffusion welding: welding multiple layers of plates together by vacuum diffusion welding.
